(19) United States
(12) Patent Application Publication
(10) Pub. No.: US 2021/0091382 A1
(43) Pub. Date: Mar. 25, 2021

(54) HIGH ENERGY-DENSITY CATHODE MATERIALS FOR SECONDARY LITHIUM ION BATTERIES

(71) Applicant: Northwestern University, Evanston, IL (US)

(72) Inventors: Christopher M. Wolverton, Wilmette, IL (US); Zhenpeng Yao, Skokie, IL (US); Soo Kim, Skokie, IL (US); Jiangang He, Evanston, IL (US); Vinay Ishwar Hegde, Chicago, IL (US)

(21) Appl. No.: 16/954,736

(22) PCT Filed: Dec. 20, 2018
(86) PCT No.: PCT/US18/66750

§ 371 Date: Jun. 17, 2020

Related U.S. Application Data
(60) Provisional application No. 62/609,620, filed on Dec. 22, 2017.

(51) Int. Cl. H01M 4/525; H01M 10/0525; H01M 4/505; H01M 4/485; C01G 45/12; C01G 49/00; C01G 55/00

(52) U.S. Cl. CPC H01M 4/525; H01M 10/0525; H01M 4/505; H01M 2004/028; C01G 45/1285; C01G 49/009; C01G 55/002; H01M 4/485

(57) ABSTRACT

Cathode materials for lithium ion batteries, lithium ion batteries incorporating the cathode materials, and methods of operating the lithium ion batteries are provided. The materials are composed of lithium metal oxides that include two different metals.

### CROSS-REFERENCE TO RELATED APPLICATIONS

The present application claims priority to U.S. provisional patent application No. 62/609,620 that was filed Dec. 22, 2017, the entire contents of which are hereby incorporated herein by reference.

### REFERENCE TO GOVERNMENT RIGHTS

This invention was made with government support under DEAC02-06CH11357 awarded by the U.S. Department of Energy; under 70NANB14H012 awarded by the Dept. of Commerce and NIST; under N00014-13-P-1056 awarded by the DOD, Office of Navy Research; and under DMR1309957 awarded by the NSF. The government has certain rights in the invention.

### BACKGROUND

Lithium-ion batteries (LIBs) have become one of the most widely-used electrical energy storage technologies and have enabled the wireless revolution of consumer electronics. Conventional cathode materials used in LIBs are typically lithium-containing transition metal (TM) oxides or phosphates that can store and release electrical energy via the insertion and extraction of Li⁺ ions, accompanied by redox reactions of the TM cation. Recently, Freire et al. reported a new disordered rocksalt-type Li-excess Li₄Mn₂O₅ cathode material with partially occupied cation and anion sites that exhibits a high discharge capacity. (See, M. Freire et al., A new active Li—Mn—O compound for high energy density Li-ion batteries. Nat. Mater. 15, 173-177 (2016).)

### SUMMARY

Cathode materials for lithium ion batteries and lithium ion batteries incorporating the cathode materials are provided.

One embodiment of a lithium ion battery comprises: an anode; a cathode comprising a lithium mixed metal oxide compound in electrical communication with the anode, wherein the lithium mixed metal oxide compound has the formula Li₄(Mix)₂O₅, where Mix represents two or more metal cations, including a first metal cation, M, and one or more dopant metal cations, M′, the lithium mixed metal oxide compound being characterized in that it can be reversibly converted into a lithium mixed metal oxide having an energetically stable state in which the M′ cations have a valence of 5+ or above during the redox cycle of the battery; and an electrolyte disposed between the anode and the cathode

One embodiment of a lithium ion battery comprises: an anode; a cathode comprising lithium metal oxides in electrical communication with the anode, wherein the lithium metal oxides have the formula Li₄M₍₂₋ₓ₎M′ₓO₅, where M and M′ represent different metal cations and 0<x<2; and an electrolyte disposed between the anode and the cathode.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A-1D. Determining the rocksalt type structure of Li₄Mn₂O₅. (FIG. 1A) A schematic illustration of the disordered rocksalt Li₄Mn₂O₅ structure with Li/Mn randomly mixed on the cationic sites and oxygen/vacancies (O/Vac) randomly mixed on the anionic sites. (FIG. 1B) Simulated disordered structure using the special quasi-random structure (SQS) method. (FIG. 1C) Predicted ground-state structure of Li₄Mn₂O₅, with all Mn octahedrally coordinated by O atoms and Li ions square-planarly or square-pyramidally coordinated because of O/Vac neighboring (space group Cmnmm). (FIG. 1D) Total energy distribution of the 100 structures selected, the SQS structure, and the Na₄Mn₂O₅ prototype structure from Density Functional Theory (DFT) calculations. The Cmmm structure exhibits the lowest total energy.

FIG. 2A-2C. Thermodynamic and dynamic stabilities of Li₄Mn₂O₅. (FIG. 2A) Calculated Li—Mn—O (T=0 K) phase diagram. The Li₄Mn₂O₅ phase is slightly higher in energy (13.6 meV/atom) relative to that of the ground state phases—a mixture of Li₂O and LiMnO₂. (FIG. 2B) Phonon dispersion of ground-state Li₄Mn₂O₅ and (FIG. 2C) calculated temperature-dependent free energy of Li₄Mn₂O₅, Li₂O, and LiMnO₂, as well as the stability of Li₄Mn₂O₅ vs. temperature relative to Li₂O and LiMnO₂ phase mixtures. It was found that Li₄Mn₂O₅ is dynamically stable and can be entropically stabilized at ˜1350 K.

FIGS. 3A and 3B. Electrochemical delithiation process of Li₄Mn₂O₅. (FIG. 3A) Li₄Mn₂O₅—Mn₂O₅ convex hull with calculated delithiated structures generated from ordered and disordered (SQS) Li₄Mn₂O₅ phase. (FIG. 3B) Corresponding voltage profile during the delithiation process in Li₄Mn₂O₅, which showed excellent agreement with the experimentally obtained charging curve. (M. Freire et al., 2016.)

FIG. 4A-4E. Cationic and anionic redox sequence during the delithiation of Li₄Mn₂O₅. (FIG. 4A) Local atomistic environments for Mn and O ions in LiₓMn₂O₅ (x=4, 3, 2, 1, and 0). (FIG. 4B) Energies needed to oxidize octahedrally coordinated Mn³⁺(d⁴) and Mn⁴⁺(d³) and tetrahedrally coordinated Mn⁴⁺(d³) to the reference state E_{R} (Li metal) (indicated by the arrows). p-DOS of the O 2p and Mn 3d orbitals (e_{g}, t_{2g}) of O²⁻ ions in the ‘Li—O—Li’ configurations and the nearest Mn ions in (FIG. 4C) Li₄Mn₂O₅ and (FIG. 4D) Li₂Mn₂O₅. (FIG. 4E) Energy difference between ordered and disordered Mn₂O₅ with the partial Mn migration from octahedral to tetrahedral sites. The redox reaction along with the Li₄Mn₂O₅ delithiation proceeds in three steps: i) cationic Mn³⁺/Mn⁴⁺ (4>x>2), ii) anionic O²⁻/O¹⁻ (2>x>1), and ii) mixed cationic Mn⁴⁺/Mn⁵⁺ and anionic O²⁻/O¹⁻ (1>x>0). The oxidation of Mn⁴⁺ to Mn⁵⁺ necessitated the migration of the Mn ion from its octahedral site to a nearby unoccupied tetrahedral site and impaired the reaction reversibility.

FIG. 5. HT-DFT screening for doping into the Mn sublattice in the Li₄(Mn,M)₂O₅ cathode system. Computational screening of mixing on the Mn sites with metal cations (M) that produce energetically stable Li₄(Mn,M)₂O₅ mixtures and have stable 5+ oxidation states was performed by examining the mixing energy and Li₄M₂O₅ stability. The top candidates with −30<Eₘᵢₓ<30 meV/site and the lowest formation energies are presented. The top three TM dopant candidates in the Li₄(Mn,M)₂O₅ system are located in the left center of the plot: M=V, Fe, and Cr.

FIG. 6. The cationic ordering between Li and Mn in Li₄Mn₂O₅ and between Ga and Zr in Ga₂Zr. The cationic ordering between Li₄Mn₂O₅ and Ga₂Zr is identical.

FIG. 7. The phonon dispersion of the ground state LiMnO₂.

FIG. 8. The phonon dispersion of the ground state Li₂O.

FIGS. 9A and 9B. The magnetization and oxidation state evolution of (FIG. 9A) Mn and (FIG. 9B) O ions in intermediate phases LiₓMn₂O₅ (x=4, 3, 2, 1, and 0) during delithiation. In nearly-delithiated intermediated phases (x=2, 1, 0_{SQS}, 0_{ordered}), oxidation states of Mn and O ions are not identical with the partition of certain oxidation state marked by fractions (i.e. ⅕N). Mn and O magnetizations show wide distribution in the x=0 phase as a result of the various local environments of Mn in the disordered SQS structure. The electronic configurations of Mn³⁺, Mn⁴⁺, Mn⁵⁺, O²⁻, and O¹⁻ are presented. Mn and O magnetizations in ordered Mn₂O₅ are shown as a reference.

### DETAILED DESCRIPTION

Cathode materials for lithium ion batteries, lithium ion batteries incorporating the cathode materials, and methods of operating the lithium ion batteries are provided. The materials are composed of a lithium mixed metal oxide compound in electrical communication with the anode, wherein the lithium mixed metal oxide compound has the formula Li₄(Mix)₂O₅, where Mix represents two or more metal cations, including a first metal cation, M, and one or more dopant metal cations, M′. The lithium mixed metal oxide compounds are characterized in that they have an energetically stable state in which the valence of M′ is 5+ or above that is accessible during the Mn⁴⁺/Mn⁵⁺ redox process that takes place during the charging and discharging of the battery. In some embodiments of the cathode materials, the mixed metal oxide compound has the formula Li₄M₍₂₋ₓ₎M′ₓO₅, where 0<x<2. In this formula, M′ can represent a single dopant metal cation or it can represent more than one (for example, two) dopant metal cation. In some embodiments of the compounds, 0<x<1.

A basic embodiment of a lithium ion battery includes: a cathode; an anode in electrical communication with the cathode; an electrolyte disposed between the anode and the cathode; and, optionally, a separator also disposed between the anode and the cathode.

The electrolytes are ionically conductive materials and may include solvents, ionic liquids, metal salts, ions such as metal ions or inorganic ions, polymers, ceramics, and other components. An electrolyte may be an organic or inorganic solid or a liquid, such as a solvent (e.g., a non-aqueous solvent) containing dissolved salts. Non-aqueous electrolytes can include organic solvents, such as cyclic carbonates, linear carbonates, fluorinated carbonates, benzonitrile, acetonitrile, tetrahydrofuran, 2-methyltetrahydrofuran, γ-butyrolactone, dioxolane, 4 methyldioxolane, NN-dimethylformamide, N,N-dimethylacetamide, N,N-dimethylsulfoxide, dioxane, 1,2-dimethoxyethane, sulfolane, dichloroethane, chlorobenzene, nitrobenzene, diethyleneglycol, dimethylether, and mixtures thereof. Example salts that may be included in electrolytes include lithium salts, such as LiPF₆, LiBF₄, LiSbF₆, LiAsF₆, LiCIO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂) (C_{y}F_{2y-1}SO₂), (where χ and y are natural numbers), LiCl, LiI, and mixtures thereof. During battery operation, lithium ions can be inserted/extracted reversibly from/to the electrolyte of the battery to/from the lithium sites of the cathode materials during the discharge and charge cycles of the cell, as illustrated in the reactions shown in Table 2.

The separators are typically thin, porous or semi-permeable, insulating films with high ion permeabilities. The separators can be composed of polymers, such as olefin-based polymers (e.g., polyethylene, polypropylene, and/or polyvinylidene fluoride). If a solid polymer electrolyte is used as the electrolyte, the solid polymer electrolyte may also act as the separator.

The anodes are composed of an active anode material that takes part in an electrochemical reaction during the operation of the battery. Example anode active materials include elemental materials, such as lithium; alloys including alloys of Si and Sn, or other lithium compounds; and intercalation host materials, such as graphite. By way of illustration only, the anode active material may include a metal and/or a metalloid alloyable with lithium, an alloy thereof, or an oxide thereof. Metals and metalloids that can be alloyed with lithium include Si, Sn, Al, Ge, Pb, Bi, and Sb. For example, an oxide of the metal/metalloid alloyable with lithium may be lithium titanate, vanadium oxide, lithium vanadium oxide, SnO₂, or SiOₓ (0<x<2).

The cathodes include lithium metal oxides that take part in an electrochemical reaction during the operation of the battery. Some embodiments of the cathodes comprise lithium metal oxides that include only one other metal element in addition to lithium and have a stoichiometry represented by the formula Li₄M₂O₅. In some embodiments of these lithium metal oxides, M is a metal other than Mn. In some embodiments of these lithium metal oxides, M is V, Fe, Cr, Pd, or Rh. This formula can be considered nominal in that it may be virtually impossible to get rid of very low (e.g., trace) concentrations of impurities in the synthesis of any chemical compound. These impurities, when present, are generally inert but may result in very small deviations from the stoichiometry represented in the formula. Such inert metal impurities may be introduced into the compounds as the result of impurities present in the materials used to synthesize the compounds and/or due to impurities present in the synthesis environment. Typically, such inert metal impurities are present in very small amounts, for example, at concentrations of 1 ppm or lower, including 1 ppb or lower. However, the electrochemically inert metal elements can also be present at higher concentrations, provided that they do no materially affect the operation of the cathode.

Other embodiments of the cathodes comprise mixed metal lithium metal oxides having the formula Li₄(Mix)₂O₅. Some embodiments of the mixed metal oxide compounds include electrochemically inert metal elements in addition to the M and M′ elements, where an electrochemically inert metal element is a metal element that does not alter the electrochemical properties (performance) of the electrode. The lithium mixed metal oxide compounds include compounds having the formula Li₄M₍₂₋ₓ₎M′ₓO₅, where M and M′ represent different metal cations, and 0<x<2. This formula can be considered nominal in that it may be virtually impossible to get rid of very low (e.g., trace) concentrations of impurities in the synthesis of any chemical compound. These impurities, when present, are generally inert but may result in very small deviations from the stoichiometry represented in the formula. Such inert metal impurities may be introduced into the compounds as the result of impurities present in the materials used to synthesize the compounds and/or due to impurities present in the synthesis environment. Typically, such inert metal impurities are present in very small amounts, for example, at concentrations of 1 ppm or lower, including 1 ppb or lower. However, the electrochemically inert metal elements can also be present at higher concentrations, provided that they do no materially affect the operation of the cathode.

In some embodiments of the lithium metal oxides, M is Mn and/or M′ is Cr, Fe, V, Rh, or Pd. In the mixed metal oxide compounds in which M is Mn, the M′ metal elements (e.g., transition metal elements) partially substitute Mn in Li₄Mn₂O₅. As illustrated in the Example, the lithium mixed metal oxide compounds can be reversibly converted into an energetically stable state in which the M′ elements can access the oxidation state of 5+ or above during the Mn⁴⁺/Mn⁵⁺ redox process, thereby eliminating the need for oxidation of Mn to 5+. The lithium metal oxides may be free of noble metal elements in order to reduce raw material costs.

Batteries incorporating the cathode material are able to provide a high specific capacity. For example, some embodiments of the batteries have a specific capacity of at least 300 mAh/g. As such, the batteries are useful for a variety of devices, including consumer electronics and power devices, electric vehicles, distributed energy storage for solar and wind, and advanced electric energy storage for smart grid applications.

The preparation of Li₄M₂O₅, Li₄M₍₂₋ₓ₎M′ₓO₅, or Li₄(Mix)₂O₅ compounds could proceed through a two-step route, using a mechanochemical activation. First, high-temperature (HT)-LiMO₂ compounds, HT-LiM′O₂, or HT-Li(MM′)₂ are produced by a solid-state reaction method using a reagent mixture of LiOH and metal oxide compounds (e.g., MO, MO₂, M₂O₃, M′O₂, M′O₂, M′₂O₃, or mixtures of two or more thereof), taken in a corresponding molar ratio, which is ground thoroughly. By way of illustration, the metal oxide compounds may be MnO+MnO₂, V₂O₃, Cr₂O₃, Fe₂O₃, Rh₂O₃, and/or PdO+Pd(NH₃)₂Cl₂. Different M or M′ containing oxide precursors also could be used. Excess lithium compound can be added to compensate for lithium evaporation at high temperatures. Second, the homogeneous mixture is heat-treated at high temperature (for example, around 1,000° C.) under inert gas (e.g., argon) flow. Then, HT-LiMO₂, HT-LiM′O₂, or HT-Li(MM′)O₂ is ground with Li₂O (2:1 molar ratio) and 5 wt. % of carbon black to form Li₄M₂O₅ or Li₄M₍₂₋ₓ₎M′ₓO₅. (See, M. Freire et al., 2016 for guidance on the general steps described above.)

Unless otherwise indicated, temperature and/or pressure dependent measured and calculated values recited herein refer to the values as measured or calculated at room temperature (23° C.) and atmospheric pressure.

### EXAMPLE

In this example, the disordered rocksalt Li₄Mn²O₅ structure was simulated through the SQS method (with Li/Mn mixing on the cation sublattice of rocksalt and O/Vac mixing on the anion sublattice). The ground state ordered Li₄Mn₂O₅ structure was also determined via DFT-based calculations. The ordered structure as determined was predicted to have much lower energy (−119 meV/atom) compared to the disordered structure. Next, the structural evolution of phases during the delithiation of Li₄Mn₂O₅ was investigated, and these phases were used to compute delithiation voltage profiles. The DFT-calculated voltages show excellent agreement with the experimentally-measured ones. (See, M. Freire et al., 2016.) The TM and O redox sequences of Mn³⁺/Mn⁴⁺/Mn⁵⁺ and O²⁻/O¹⁻ were further elucidated during the charging cycle and showed that the electrochemical delithiation process of Li₄Mn₂O₅ occurred in the following three-step reaction pathway: 1) initial oxidation of Mn³⁺ to Mn⁴⁺ for LiₓMn₂O₅ (4>x>2), 2) followed by anionic redox of O²⁻ to O¹⁻ for LiₓMn₂O₅ (2>x>1), and finally 3) further cation oxidation of Mn⁴⁺ to Mn⁵⁺ for LiₓMn₂O₅ (1>x>0), validating the observations of Freire et al. (2016). The calculations show that the oxidation of Mn⁴⁺ to Mn⁵⁺ imposed a migration of the Mn ion from its octahedral site to a nearby, unoccupied tetrahedral site. Lastly, computational screening of mixing was performed on the Mn sites with metal cations (M) that produce energetically stable Li₄(Mn,M)₂O₅ mixtures, and also have stable 5+ oxidation states. This approach demonstrates that alloying this compound with the following elements produces new compounds with substantially improved electrochemical properties, particularly for embodiments in which M=V and Cr in Li₄(Mn,M)₂O₅.

### Results and Discussions

Determining the Rocksalt Type Structure of L₄Mn₂O₅

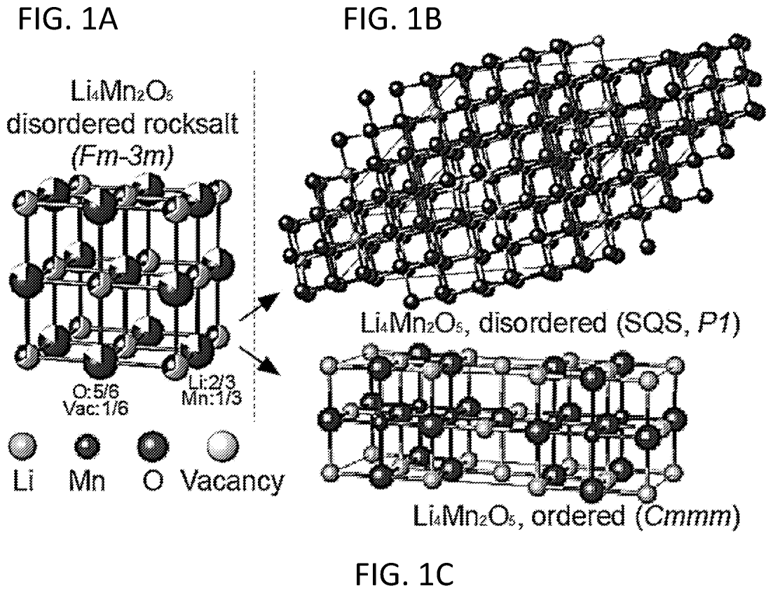

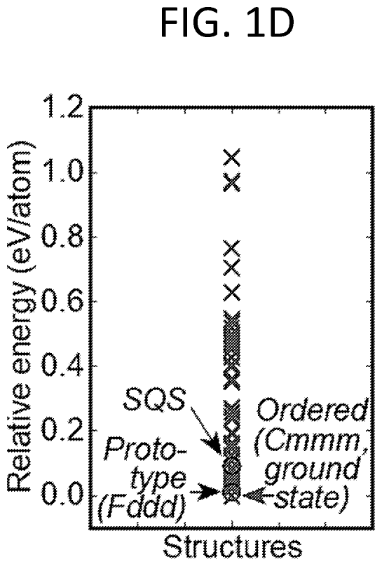

The X-ray diffraction analysis of the Li₄Mn₂O₅ samples led to several broad peaks, indicating a disordered rocksalt type structure with Li/Mn randomly mixed on the cation sites and O/Vac randomly mixed on the anion sites (FIG. 1A). Here, the SQS method was employed, using a rocksalt-based 108-site supercell with Li/Mn occupying the 54 cation sites in a 2:1 ratio, and O/Vac occupying the 54 anion sites in a 5:1 ratio. The SQS was generated (FIG. 1B) using a Monte Carlo algorithm as implemented in the ATAT package with the pair and triplet correlation functions of the SQS constrained to be identical to those of the statistically random compound (Li/Mn occupying the cation sites, and O/Vac occupying the anion sites) at least up to the third nearest neighbor. (See, E. Cockayne, et al., Building Effective Models from Scarce but Accurate Data: Application to an Alloy Cluster Expansion Model. Phys. Rev. B. 81, 12104-12113 (2010); A. van de Walle, Multicomponent Multisublattice Alloys, Nonconfigurational Entropy and Other Additions to the Alloy Theoretic Automated Toolkit. Calphad. 33, 266-290 (2009); and A. van de Walle, Methods for First-Principles Alloy Thermodynamics. JOM—J. Min. Met. Mat. S. 65, 1523-1532 (2013).)

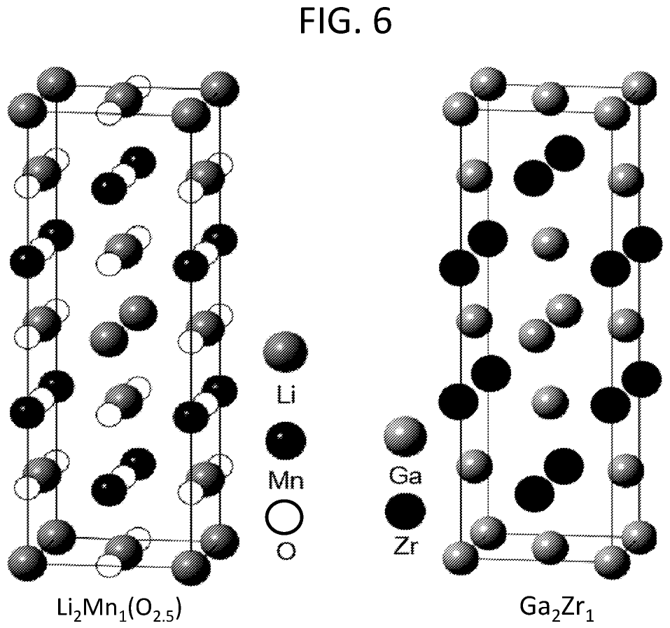

In addition, ionic ordering in the Li₄Mn₂O₅ compound was studied. The lowest-energy, ground state structure of Li₄Mn₂O₅ was determined by exploring a vast number of geometrically-distinct Li/Mn/O ordered configurations using DFT calculations. Starting from the cubic rocksalt primitive cell, two sets of supercells were generated: 1) containing 6 cations and 6 anions with all symmetrically distinct supercell shapes; 2) containing 12 cations and 12 anions with two specific shapes, given by 3×2×2 and 2×3×2 multiples of the primitive rocksalt unit cell. The cation sites were then populated with Li and Mn atoms in the ratio 2:1, and Vac were introduced on the anion sites with a Vac:O ratio of 1:5. 616 geometrically different configurations were generated using the Enum code. (See, G. Hart, et al., Algorithm for Generating Derivative Structures. Phys. Rev. B. 77, 224115-224126 (2008); G. L. W. Hart, et al., Generating derivative structures from multilattices: Algorithm and application to hcp alloys. Phys. Rev. B. 80, 014120-014127 (2009); and G. L. W. Hart, et al., Generating Derivative Structures at A Fixed Concentration. Comput. Mater. Sci. 59, 101-107 (2012).) The electrostatic total energy for all configurations were calculated using nominal charge states for the ions in the system as a quick energy sampling step. (See, K. J. Michel, et al., Fast Mass Transport Kinetics in B20H16: A High-Capacity Hydrogen Storage Material. J. Phys. Chem. C. 117, 19295-19301(2013).) All structures were ranked by their normalized electrostatic energies. The 100 Li₄Mn₂O₅ structures with the lowest electrostatic energies were fully relaxed, and their energies were calculated using DFT. The structure with the lowest DFT total energy, i.e., the ground state structure of Li₄Mn₂O₅, was found to have a space group of Cmmm with all Mn³⁺ ions octahedrally-coordinated by 6 oxygen atoms (FIG. 1C). Meanwhile, Li ions were square-planarly or square-pyramidally coordinated by 4 or 5 oxygen atoms as a result of O/Vac neighboring. The cation ordering between Li and Mn in the Li₄Mn₂O₅ ground state structure was the ordering of the Ga₂Zr compound (see FIG. 6), with crystallographic information given in Table 1. (See, K. Schubert, et al., Zum Aufbau einiger T4-B3 homologer und quasihomologer Systeme. I. Die Systeme Ti—Ga, Zr—Ga und Hf—Ga. Naturwissenschaften. 53, 474-488 (1962).) The fully-relaxed DFT energy of the SQS structure was found to be higher than the ordered ground state by 119 meV/atom (34 ordered structures having lower total energies (FIG. 1D)). The thermodynamic and dynamical stability of the ordered Cmmm Li₄Mn₂O₅ structure is discussed in detail in the following section.

TABLE 1
Structure information of the Li₄Mn₂O₅ ground state. Space group name: Cmmm.
Lattice parameters: a = 4.0390 Å, b = 12.4312 Å, c = 4.0268 Å, α = β = γ = 90.0000°.
Structure parameters:

| Atom | x | y | z | occupancy |
|---|---|---|---|---|
| Li1 | 0.0000 | 0.0000 | 0.0000 | 1 |
| Li2 | 0.5000 | 0.5000 | 0.0000 | 1 |
| Li3 | 0.0000 | 0.5000 | 0.5000 | 1 |
| Li4 | 0.5000 | 0.0000 | 0.5000 | 1 |
| Li5 | 0.0000 | 0.6847 | 0.0000 | 1 |
| Li6 | 0.5000 | 0.1847 | 0.0000 | 1 |
| Li7 | 0.5000 | 0.8153 | 0.0000 | 1 |
| Li8 | 0.0000 | 0.3153 | 0.0000 | 1 |
| Mn1 | 0.0000 | 0.1594 | 0.5000 | 1 |
| Mn2 | 0.5000 | 0.6594 | 0.5000 | 1 |
| Mn3 | 0.5000 | 0.3406 | 0.5000 | 1 |
| Mn4 | 0.0000 | 0.8406 | 0.5000 | 1 |
| O1 | 0.0000 | 0.0000 | 0.5000 | 1 |
| O2 | 0.5000 | 0.5000 | 0.5000 | 1 |
| O3 | 0.0000 | 0.6669 | 0.5000 | 1 |
| O4 | 0.5000 | 0.1669 | 0.5000 | 1 |
| O5 | 0.5000 | 0.8314 | 0.5000 | 1 |
| O6 | 0.0000 | 0.3331 | 0.5000 | 1 |
| O7 | 0.0000 | 0.1557 | 0.0000 | 1 |
| O8 | 0.5000 | 0.6557 | 0.0000 | 1 |
| O9 | 0.5000 | 0.3443 | 0.0000 | 1 |
| O10 | 0.0000 | 0.8143 | 0.0000 | 1 |

Li—Mn—O Phase Diagram and Thermodynamic Stability of Ordered (Cmmm) Li₄Mn₂O₅

Phase diagrams represent the thermodynamic phase equilibria of multicomponent systems and provide useful information on reactions of phases. While the experimental determination of a phase diagram for specific system is significantly time and labor consuming, the phase diagram constructions can be accelerated by calculating energies of all known compounds in a specific chemical system using DFT and using them to construct a T=0K convex hull. (See, A. R. Akbarzadeh, et al., First-Principles Determination of Multicomponent Hydride Phase Diagrams: Application to the Li—Mg—N—H System. Adv Mater. 19, 3233-3239 (2007); C. Wolverton, et al., Incorporating first-principles energetics in computational thermodynamics approaches. Acta Mater. 50, 2187-2197 (2002).) In this study, ternary Li-M-O ground state convex hulls were constructed using the structures with the lowest energy for each composition for M=Mn and all metal elements with possible oxidation states of 5+ or above: i.e., M=Bi, Cr, Fe, Ir, Mo, Nb, Os, Pd, Pr, Pt, Re, Rh, Ru, Sb, Ta, V, and W. (See, N. N. (Norman N. Greenwood, et al., Chemistry of the elements (Butterworth-Heinemann, 1997).) All compounds within each Li-M-O ternary system were adopted from the Inorganic Crystal Structure Database (ICSD). (See, A. Belsky, et al., New Developments in the Inorganic Crystal Structure Database (ICSD): Accessibility in Support of Materials Research and Design. Acta Crystallogr. Sect. B Struct. Sci. 58, 364-369 (2002).) The elemental reference states (Li, M, non-solid O₂) were obtained by fitting to experimental formation energies, mainly from two major databases: the SGTE substance database (SSUB) and a database constructed by P. Nash et al. (See, S. Grindy, et al., Approaching Chemical Accuracy with Density Functional Calculations: Diatomic Energy Corrections. Phys. Rev. B. 87, 075150-075157 (2013); L. Wang, et al., Oxidation Energies of Transition Metal oxides within the GGA+U framework. Phys. Rev. B. 73, 195107-195112 (2006); S. Kirklin et al., The Open Quantum Materials Database (OQMD): Assessing the Accuracy of DFT Formation Energies. npj Comput. Mater. 1, 15010-15024 (2015): V. Stevanović, et al., Correcting density functional theory for accurate predictions of compound enthalpies of formation: Fitted elemental-phase reference energies. Phys. Rev. B. 85, 115104-115115 (2012); SGTE, Thermodynamic Properties of Inorganic Materials (Berlin, Heidelberg, 1999); and P. Nash, Thermodynamic database (2013).) Calculations to construct equilibrium Li-M-O phase diagrams were carried out within the Open Quantum Materials Database (OQMD) framework. (See, S. Kirklin et al., The Open Quantum Materials Database (OQMD): Assessing the Accuracy of DFT Formation Energies. npj Comput. Mater. 1, 15010-15024 (2015); and J. E. Saal, et al., Materials Design and Discovery with High-Throughput Density Functional Theory: The Open Quantum Materials Database (OQMD). JOM. 65, 1501-1509 (2013).) The convex hull of stable phases, i.e., the set of compounds that have an energy lower than that of any other compound or linear combination of compounds at that composition, was constructed for each ternary Li-M-O system. Using such convex hulls, or T=0K phase diagrams, the ground state stability of transition metal oxides, e.g., Li₄M₂O₅ and Li₄(Mn,M)₂O₅, could then be evaluated by using the GCLP technique. (See, S. Kiridin et al., The Open Quantum Materials Database (OQMD): Assessing the Accuracy of DFT Formation Energies. npj Comput. Mater. 1, 15010-15024 (2015); and A. Jain et al., Commentary: The Materials Project: A materials genome approach to accelerating materials innovation. APL Mater. 1, 11002 (2013).)

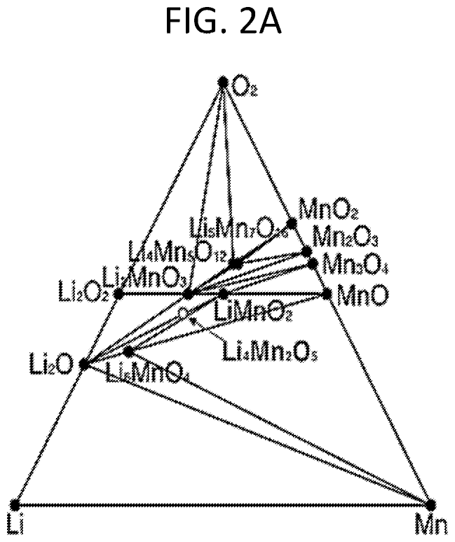

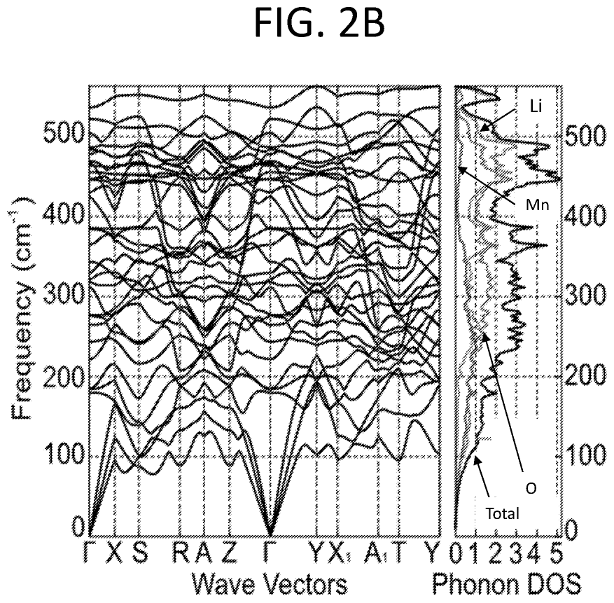

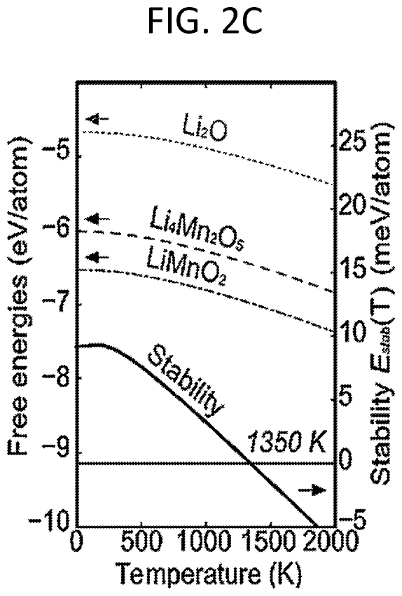

The Li—Mn—O phase diagram (T=0 K) is shown in FIG. 2A with the ground state, stable compounds marked by filled circles (i.e., having lower energy than the linear combination of other structures). Li₄Mn₂O₅ is shown as an empty circle, which is compositionally located on the tie-line between Li₂O and LiMnO₂. Li₄Mn₂O₅ at T=0 K was predicted to have an energy only slightly higher (+13.6 meV/atom) than a two-phase mixture of Li₂O and LiMnO₂. The Li₄Mn₂O₅ compound is, therefore, not a ground state structure, but rather is unstable at T=0 K, albeit by a very small energy. The compound is very close to the convex hull, and hence may be stabilized at elevated temperatures by entropic contributions, e.g., vibrational entropy. The DFT calculated phonon dispersion of the Cmmm Li₄Mn₂O₅ is provided in FIG. 2B. No imaginary phonons are shown in FIG. 2B, which indicates the predicted Li₄Mn₂O₅ compound was dynamically stable.

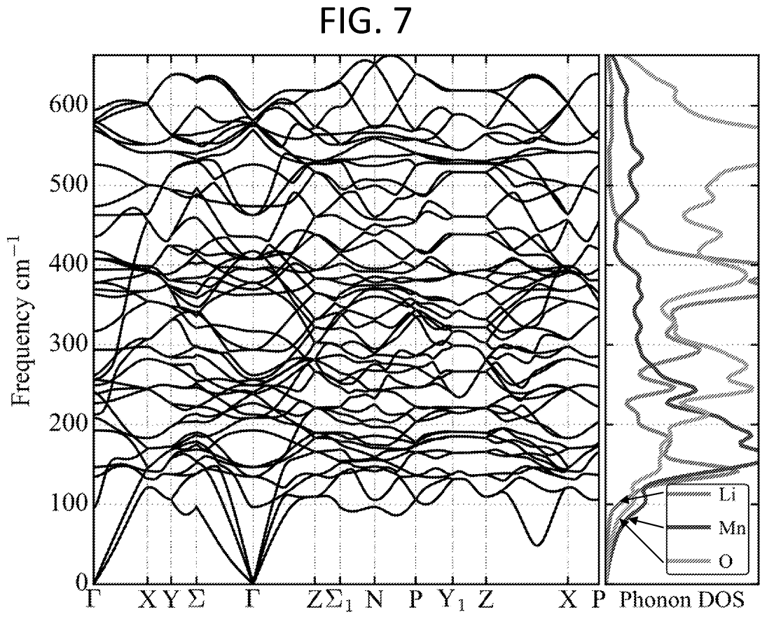

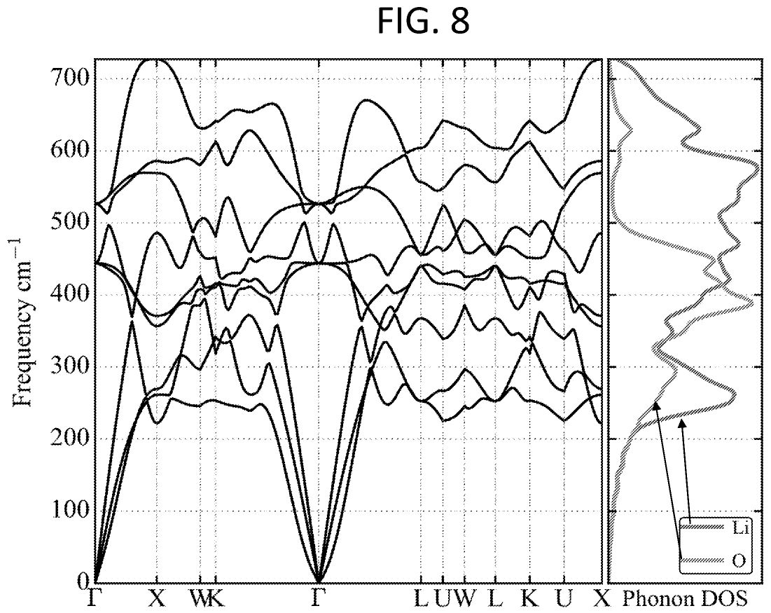

By computing the harmonic phonons and vibrational entropies of Li₄Mn₂O₅ (FIG. 2B), LiMnO₂(FIG. 7), and Li₂O (FIG. 8), the temperature dependence of the free energies can be calculated between these three competing phases. It was found that Li₄Mn₂O₅ has a higher entropy than the combination of Li₂O and LiMnO₂, suggesting that Li₄Mn₂O₅ should become stable at elevated temperatures. The temperature-dependent free energy curves (FIG. 2C), F(T)=E−TS, consist of the energy of a static lattice and the harmonic vibrational free energy at the same volume. Both Li₂O and LiMnO₂ were calculated to be dynamically stable, having only real phonon frequencies. Using the free energies for each of the three compounds, the stability (formation free energy) for Li₄Mn₂O₅ can be calculated as Stability (Li₄Mn₂O₅)═F(Li₄Mn₂O)—F(Li₂O)-2F(LiMnO₂). The stability of Li₄Mn₂O₅ as the function of T is shown in FIG. 2C with a temperature at which Li₄Mn₂O₅ is stabilized to be approximately ˜1350 K. The positive formation entropy is mainly because of the small entropy of Li₂O, stemming from the light Li atom and strong bonding interaction between Li and O as shown in FIG. 8. Due to the relatively small entropy differences between phases, the uncertainty of this temperature (e.g., due to an uncertainty of ±1 meV/atom in free energy) results in a range of transition temperatures of 1240-1450 K. The calculations then suggest that the Li₄Mn₂O₅ compound is stable at high temperatures, implying the favored formation of this compound above the transition temperature. However, the elevated temperature would also favor ionic disorder because of the greater configurational entropy contribution. The possible stable decomposition phases are LiMnO₂, Li₂O, Li₂MnO₃, Li₆MnO₄, as predicted by the Li—Mn—O phase diagram, which might be observed as “impurity” phases during synthesis.

Electrochemical Delithlation Process of Li₄Mn₂O₅ and TM/O Redox Competition

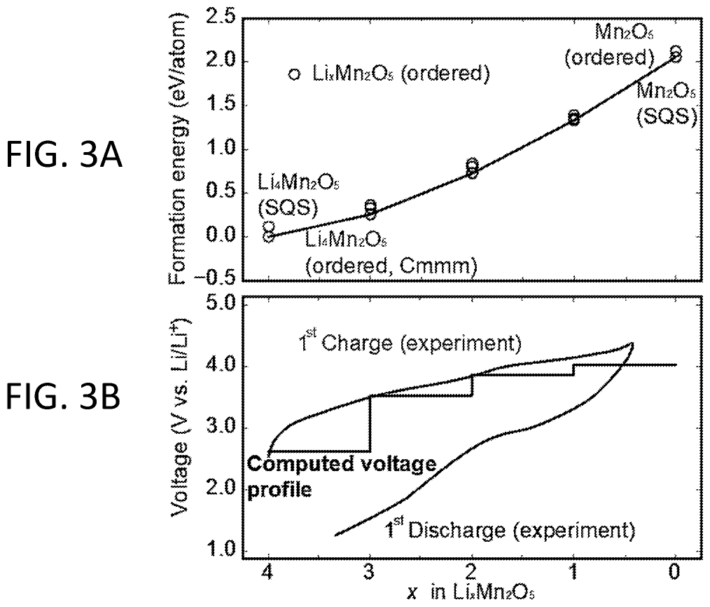

Having explored the structural ordering and thermodynamic stability of the Li₄Mn₂O₅ phase, the electrochemical delithiation process of this compound was explored next. To examine delithiation, the energies of disordered SQS-Li₄Mn₂O₅ and the fully-delithiated SQS-Li₀Mn₂O₅ were calculated. Meanwhile, compositions of LiₓMn₂O₅ (x=4, 3, 2, 1, and 0) were considered, in which (4−x) Li⁺ ion(s) were removed from the original ordered Cmmm Li₄Mn₂O₅ structure using many geometrically-distinct configurations, and they were further relaxed using DFT. The energies for these structures were evaluated according to the following reaction: LiₓMn₂O₅→Mn₂O₅+xLi⁺. The energies of these ordered/disordered delithiation products were plotted, and the delithiation convex hull of Li₄Mn₂O₅—Mn₂O₅ was then constructed, as shown in FIG. 3A. In FIG. 3A, the delithiation convex hull of Li₄Mn₂O—Mn₂O₅ is shown, where the ordered LiₓMn₂O₅ (x=3, 2, 1) and disordered SQS-LiₓMn₂O₅ (x=0) structures were found to be on the hull. Converting the energies along this delithiation pathway into voltages, it was found that the predicted voltage profile shows good general agreement with the experimental charging curve in FIG. 3B.

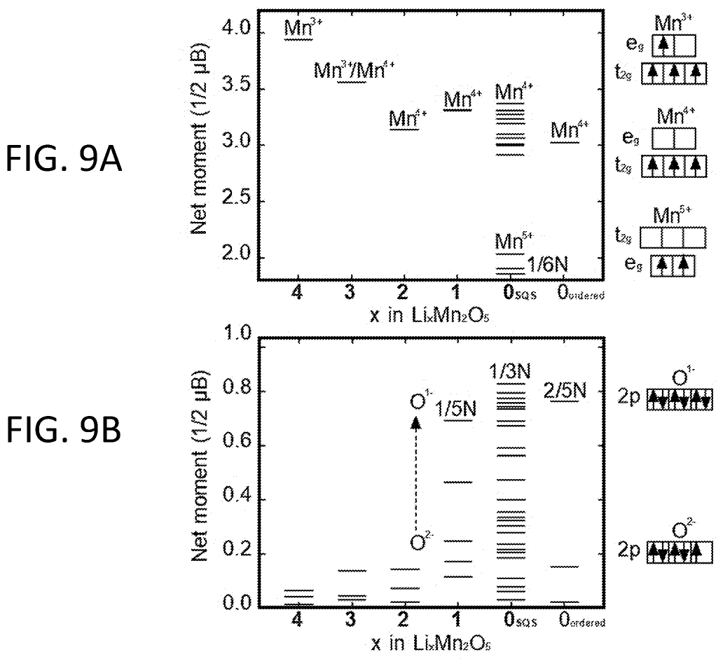

The calculations of the Li₄Mn₂O₅ phase and its delithiation products were next used to interrogate in detail the TM/O redox sequence. The oxidation states of Mn and O ions were examined during the delithiation process, and the local atomistic environments for cations and anions were investigated. The oxidation states can be determined by comparing calculated magnetizations of Mn and O ions with the number of unpaired electrons of the corresponding ions with known oxidation states. The numbers of unpaired electrons for Mn³⁺ (octahedrally-coordinated), Mn⁴⁺ (octahedrally-coordinated), and Mn⁵⁺ (tetrahedrally-coordinated) are 4, 3, and 2, respectively, as shown in FIG. 9A. The numbers of unpaired electrons for O²⁻ and O¹⁺ (octahedrally-coordinated) are 0 and 1, respectively (FIG. 9B). It was found that the electrochemical delithiation of Li₄Mn₂O₅ can be categorized in three different reaction steps, where each step contains a dominant redox of either TM or O ions:

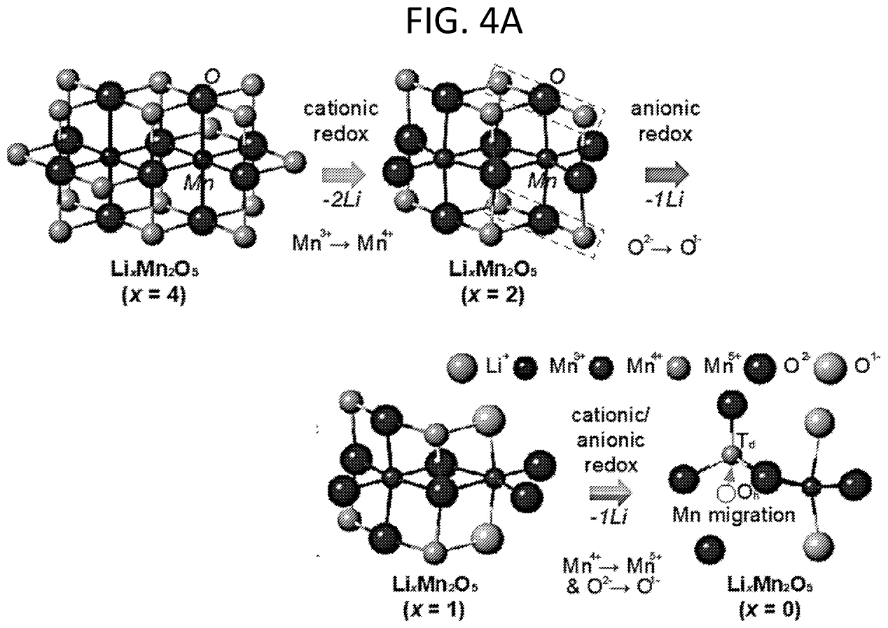

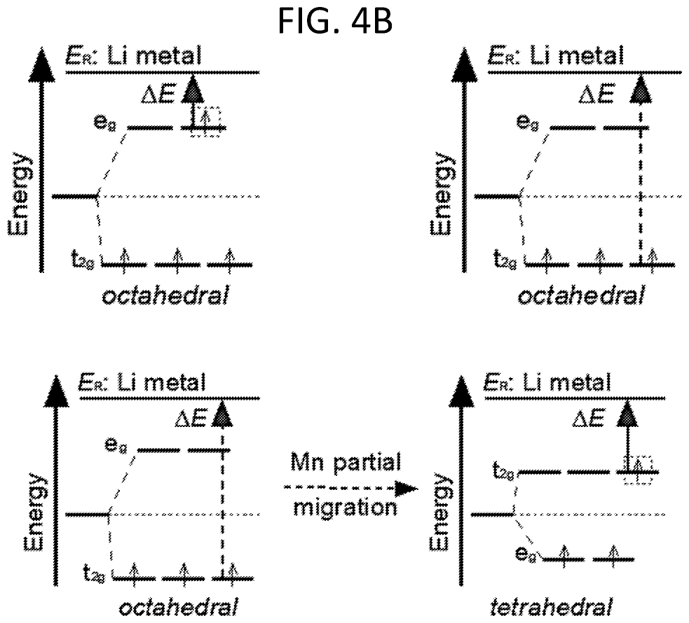

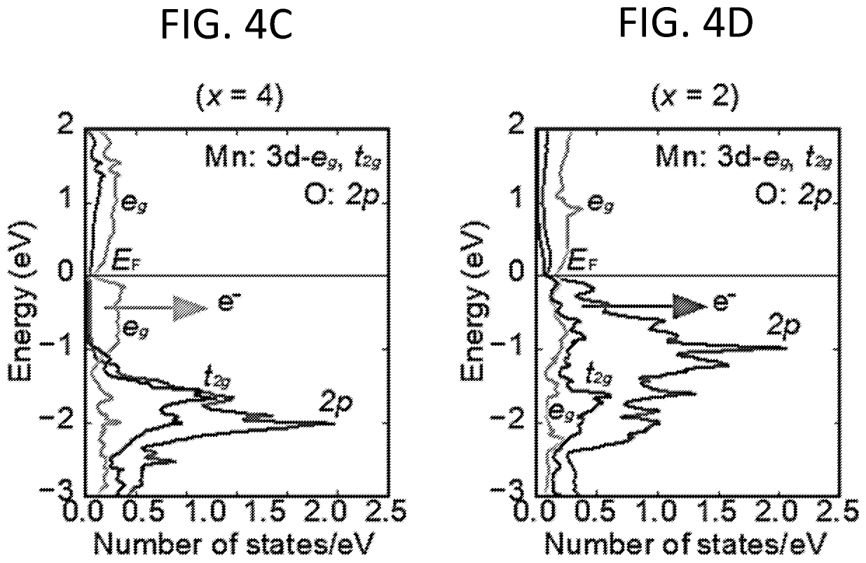

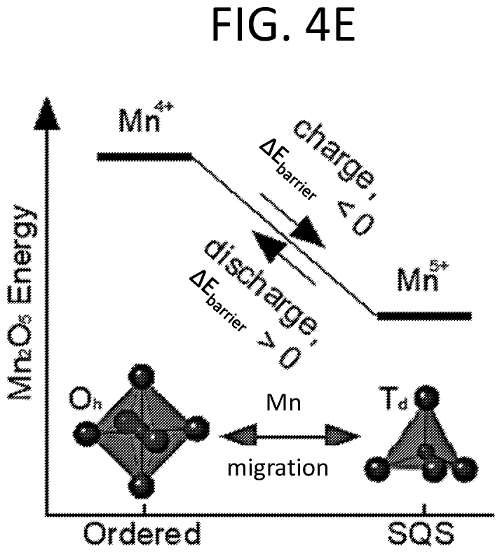

(i) Cationic redox Mn³⁺/Mn⁴⁺ delithiation (LiₓMn₂O₅, 4>x>2): During the delithiation process of Li₄Mn₂O₅→Li₃Mn₂O₅→Li₂Mn₂O₅, it was found that the Mn magnetizations decrease from 3.94μ_{B}→3.56μ_{B}→3.14μ_{B} (see FIG. 9A), indicating an overall oxidation of Mn³⁺ to Mn⁴⁺. Meanwhile, the O magnetizations retain a value between 0.01μ_{B} to 0.14μ_{B} (see FIG. 9B), implying a constant anion oxidation state of O²⁻. The initial energetic preference of TM redox over O redox was confirmed by examining the projected density of states (p-DOS) of O 2p and Mn 3d orbitals (e_{g} and t_{2g}) of O²⁻ ions and Mn³⁺ ions in both ordered and disordered Li₄Mn₂O₅. As shown in FIG. 4C, the contribution from Mn e_{g} to the valence band immediately below the Fermi level (E_{F}) was larger than that from O, which shows a preference for electron extraction from Mn (FIG. 4B) during the initial stages of the charging process as discussed above. As a result, the first delithiation step was dominated by cationic redox of Mn³⁺/Mn⁴⁺. It is interesting to connect the competition between cation and anion redox to the local ionic environments in the LiₓMn₂O₅ structures. Recently, Seo et al. proposed that a specific local Li-excess environment around the oxygen atoms (i.e., a Li—O—Li linear configuration) is a key structural signature indicating the feasibility of both cationic (TM) and anodic (oxygen) redox process in Li-rich cathode materials. (See, D.-H. Seo et al., The Structural and Chemical Origin of the Oxygen Redox Activity in Layered and Cation-disordered Li-excess Cathode Materials. Nat. Chem. 8, 692-697 (2016).) In other words, the electrons from the oxygen atom in this local Li—O—Li configuration can more easily contribute to the redox process due to the overlapping TM states and O 2p states. Interestingly, the examination of the local environments of oxygen shows that many O ions were in this Li—O—Li configuration in the ordered (Cmmm) and disordered structures, as shown in FIG. 4A. However, it was found that Mn³⁺ to Mn⁴⁺ cation oxidation was still the main redox contribution during the initial charging process. After 2 Li⁺ ions were removed (i.e., Li₂Mn₂O₅), a large fraction of 0 ions (415) still remained in these linear Li-excess environments (see FIG. 4A). The p-DOS of O 2p and Mn 3d orbitals (e_{g} and t_{2g}) for O²⁻ ions in the Li-excess environment and nearest neighbor Mn⁴⁺ ions are shown in FIG. 4D. The contribution from oxygen in the valence band immediately below E_{F} was significantly larger than that coming from Mn t_{2g}, implying the possibility of oxygen redox participation in the second delithiation step as described below. Taking extra electrons out from the t_{2g} orbital of Mn was significantly more difficult compared to the e_{g} orbital (FIG. 4B), as discussed above.

(ii) Anionic redox O²⁻/O¹⁻ dominant delithiation (LiₓMn₂O₅, 2>x>1): Upon further delithiation of Li₂Mn₂O₅ into LiMn₂O₅, it was found that the observed Mn magnetizations were largely constant in the range 3.14μ_{B} to 3.30μ_{B}, indicative of Mn⁴⁺. Here, the Mn ions still were octahedrally-coordinated. Interestingly, it was found that ⅕ of the O ions exhibited magnetic moments around 0.69μ_{B}, implying the partial oxidation of O²⁻ toward O¹⁻. By examining the local atomistic environments of all O¹⁻ ions in Li₁Mn₂O₅ and comparing to their previous local environments in Li₂Mn₂O₅, it was noticed that all O¹⁻ ions participating in redox during this step were located in the Li—O—Li Li-excess environments (FIG. 4A). The calculations thus indicate the delithiation step from Li₂Mn₂O₅ to LiMn₂O₅ was dominated by anionic redox processes (i.e., with O²⁻ being partially oxidized to O¹⁻). For the LiMn₂O₅ phase, as shown in FIG. 4E, the contribution from Mn orbitals (mainly t_{2g}) to the valence band immediately below the Fermi level (E_{F}) was still slightly lower than that from O, implying a preference for electron extraction from O (FIG. 4E) during the final stages of the charging process (LiₓMn₂O₅, 1>x>0). However, in the experimental studies, further oxidation of Mn⁴⁺ to Mn⁵⁺ was observed during this stage. (See, M. Freire et al., A new active Li—Mn—O compound for high energy density Li-ion batteries. Nat. Mater. 15, 173-177 (2016).) Therefore, it was suggested that some additional reaction mechanism must account for the Mn oxidation during the final stage.

(iii) Mixed cationic Mn⁴⁺/Mn⁵⁺ and anionic O²⁻/O¹⁻ redox delithiation (LiₓMn₂O₅, 1>x>0): During the final delithiation step, i.e., LiMn₂O₅ to Mn₂O₅ (here, the disordered SQS-Mn₂O₅ with the lowest DFT energy were examined), it was found that the Mn magnetizations were distributed from 3.3μ_{B} to 1.9μ_{B} (see FIG. 9A), indicating that Mn ions were partially (⅙) oxidized to Mn⁵⁺. At the same time, the magnetizations of ⅓ of the O ions were found to be 0.71μ_{B}˜0.82μ_{B} (FIG. 9B), implying a further oxidation of O²⁻ to O¹⁻ (remember, it was found that ⅕ of anions were O¹⁻ in LiMn₂O₅). Interestingly, as depicted in FIG. 4A, it was found that all the Mn⁵⁺ ions were tetrahedrally-coordinated in this Mn/Li vacancy disordered configuration. The observation of tetrahedrally-coordinated Mn⁵⁺ confirms the discussion above that the oxidation of tetrahedrally-coordinated Mn⁴⁺ to Mn⁵⁺ was energetically favored compared to the octahedrally-coordinated Mn⁴⁺ because of the crystal field t_{2g}/e_{g} effects (FIG. 4B). Therefore, it was suggested that the Mn ion migration to tetrahedral positions was necessary in the final delithiation process toward Mn₂O₅, which corresponds to the oxidation of Mn from 4+ to 5+. At the same time, all the Mn ions in the ordered Mn₂O₅ (dashed rectangle in FIG. 4A, 0.85 eV/Mn higher in energy compared to the disordered configuration), however, were still located in the octahedral sites, where the oxidation states were preserved at 4+, as shown in FIG. 9A. As a result, the Mn migration not only enabled the Mn⁴⁺ oxidation to Mn⁵⁺ but also lowered the energy of the system at this stoichiometry by 0.85 eV/Mn. In order to achieve a reversible redox reaction, these Mn⁵⁺ ions would need to migrate back to their original octahedral sites during the following lithiation (i.e., the discharge process). The large reverse migration barrier (i.e., at least 0.85 eV/Mn, the difference in DFT energetic stability between these two structures) will result in a significant kinetic barrier for the tetrahedral Mn to migrate back to its original octahedral position; therefore, this suggests that this metal migration will impair the reversibility of the reaction. After the extended cycling of Li₄Mn₂O₅ cathodes, it is likely that more Mn ions will migrate into the in tetrahedral sites and get trapped. The phase transformation caused by the Mn ion migrations could be one of the most significant factors for the capacity fade observed experimentally after the first cycle. (See, M. Freire et al., A new active Li—Mn—O compound for high energy density Li-ion batteries. Nat. Mater. 15, 173-177 (2016).) Improved performance and reversibility could be achieved by limiting charging to avoid the formation of Mn⁵⁺ and hence the migration of these metal cations.

The above results illustrate a design strategy to improve the extended cyclability of the rocksalt Li₄Mn₂O₅ cathodes would be to avoid Mn migration to the tetrahedral sites during the Mn⁴⁺/Mn⁵⁺ redox process. The electrochemical cycling of Li₄Mn₂O₅ could be confined to a smaller range: LiₓMn₂O₅, 4>x>1, without removing all Li from the system and oxidizing Mn to 5+. Thus, improved cyclability could be achieved by sacrificing a limited amount of capacity. An alternate strategy to achieve this goal of improved reversibility would be to partially substitute Mn in Li₄Mn₂O₅ with other TM elements that can access the oxidation state of 5+ or above, thereby eliminating the need for oxidation of Mn to 5+. In the following section, a high-throughput DFT screening strategy is presented to determine stable metal dopants (M) in Li₄(Mn,M)₂O₅ compounds.

TM Doping in LiMn₂₋ₓMₓO₅ with Accessible 5+ Oxidation State or Above

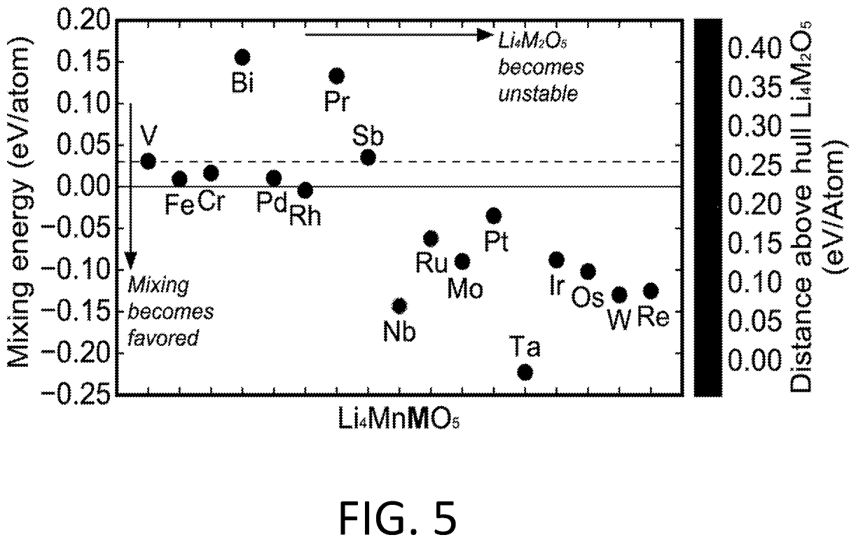

All the metal elements (M) with possible oxidation states of 5+ or above were first started with: i.e., M=Bi, Cr, Fe, Ir, Mo, Nb, Os, Pd. Pr, Pt. Re, Rh, Ru, Sb, Ta, V, and W. For each of these elements, the properties of mixed-metal Li₄(Mn,M)₂O₅ compounds were computed, specifically focusing on stability and mixing energy. The mixing energies between Li₄Mn₂O₅ and Li₄M₂O₅ in Li₄(Mn,M)₂O₅ helped determine the stability of metal mixing in this structure. When the mixing energy (Eₘᵢₓ) is found to be slightly negative or positive (near-zero, i.e. −30 to 30 meV/site), the mixing entropy at finite temperatures will overcome the mixing energy, and hence there will be a tendency for metal mixing in a solid-solution. A larger positive mixing energy (>30 meV/site) or a larger (in magnitude) negative mixing energy (<−30 meV/site) would lead to phase separation in the former case, and a quaternary ordered compound in the latter. These cases may have undesired phase transformations or possible mass transport kinetic limitations. As a result, the list of candidates was narrowed down to those with near-zero mixing energies between −30 to 30 meV/site in this study (FIG. 5). Similar to Li₄Mn₂O₅, all Li₄M₂O₅ compounds are unstable at T=0K with the potential to be entropically stabilized at finite temperatures. For cases where the Li₄M₂O₅ convex hull distance (i.e., stability) is significantly positive, it will lead to an instability of the corresponding Li₄(Mn,M)₂O₅ compound. Here, the Li₄(Mn,M)₂O₅ compounds with related Li₄M₂O₅ convex hull distance larger than 50 meV/atom were excluded. FIG. 5, indicates the top Li₄(Mn,M)₂O₅ candidates with stability near the convex hull and a small mixing energy in the Mn sublattice (favoring solid solution formation). It was predicted that mixing with M=V, Cr, Fe, Rh, and Pd would be particularly useful additives. Predicted gravimetric capacities (theoretical) and average voltages of recommended candidates are listed in Table 2. The doping/substitution of these elements into Li₄(Mn,M)₂O₅ cathodes was expected to lead to reduced phase transformation and controlled oxygen anodic chemistry for further improved electrochemical performance.

TABLE 2
Top Li₄(Mn,M)₂O₅ cathode candidates from the HT-DFT screening with predicted
gravimetric capacities (theoretical) and averaged voltages using Li₄Mn₂O₅ as the benchmark.

| | Capacity C_{g} | Voltage E_{avg} |
|---|---|---|
| Reactions | (mAh g⁻¹) | (V) |
| Li₄Mn₂O₅ → 4Li⁺ + 4e⁻ + Mn₂O₅ | 492 | 3.75 |
| Li₄MnVO₅ → 4Li⁺ + 4e⁻ + MnVO₅ | 502 | 3.10 |
| Li₄MnFeO₅ → 4Li⁺ + 4e⁻ + MnFeO₅ | 490 | 3.79 |
| Li₄MnCrO₅ → 4Li⁺ + 4e⁻ + MnCrO₅ | 499 | 3.69 |
| Li₄MnPdO₅ → 4Li⁺ + 4e⁻ + MnFeO₅ | 399 | 3.85 |
| Li₄MnRhO₅ → 4Li⁺ + 4e⁻ + MnFeO₅ | 403 | 3.80 |

### Materials and Methods

### Density Functional Theory Calculations

All DFT calculations reported in this study were performed using the Vienna Ab-initio Simulation Package (VASP) with the projector augmented wave (PAW) potentials and the Perdew-Becke-Emzerhof (PBE) exchange-correlation. (See, G. Kresse, et al., Ab Initio Molecular Dynamics for Liquid Metals. Phys. Rev. B. 47, 558-561 (1993); G. Kresse, et al., Ab Initio Molecular-dynamics Simulation of the Liquid-metal-amorphous-semiconductor Transition in Germanium. Phys. Rev. B. 49, 14251-14269 (1994); G. Kresse, et al., Efficiency of Ab-initio Total Energy Calculations for Metals and Semiconductors Using a Plane-wave Basis Set. Comput. Mater. Sci. 6, 15-50 (1996); G. Kresse, Efficient Iterative Schemes for Ab Initio Total-energy Calculations Using a Plane-Wave Basis Set. Phys. Rev. B. 54, 11169-11186 (1996); P. E. Blöchl, Projector Augmented-wave Method. Phys. Rev. B. 50, 17953-17979 (1994); and J. P. Perdew, et al., Rationale for Mixing Exact Exchange with Density Functional Approximations. J. Chem. Phys. 105, 9982-9985 (1996).) A plane wave basis with a cutoff energy of 520 eV and Γ-centered k-meshes with a density of 8000 k-points per reciprocal atom were used for all calculations. All calculations were spin-polarized, with Mn atoms initialized in a high-spin ferromagnetic configuration and relaxed to self-consistency. The DFT+U method introduced by Dudarev et al. was used to treat the localized 3d electrons of Mn with a U of 3.8, obtained by fitting it to experimental and calculated formation enthalpies in a previous study. (See, S. L. Dudarev, et al., Electron-energy-loss Spectra and The Structural Stability of Nickel Oxide: An LSDA+U Study. Phys. Rev. B. 57, 1505-1509 (1998); and L. Wang, et al., Oxidation Energies of Transition Metal oxides within the GGA+U framework. Phys. Rev. B. 73, 195107-195112 (2006).) Phonon calculations were carried out with the frozen phonon approach as implemented in the PHONOPY package, and phonon density of states was computed using a dense 30×30×30 mesh in the irreducible Brillouin zone. (See, A. Togo, et al., First-principles calculations of the ferroelastic transition between rutile-type and CaCl₂-type SiO₂ at high pressures. Phys. Rev B. 78, 134106-134114 (2008).) Further, Heyd-Scuseria-Emzerhof screened hybrid functional (HSE06), was used to accurately determine the energies, magnetic and electronic states of Mn and O in the delithiated phases with structures relaxed using DFT+U: Li₄.xMn₂O₅ (x=0, 1, 2, 3, 4). (See, J. Heyd, et al., Hybrid functionals based on a screened Coulomb potential. J. Chem. Phys. 118, 8207-8215 (2003).)

### Voltage Profile Calculations

The average lithiation/delithiation voltage (relative to Li/Li*) can be computed using the negative of the reaction free energy per Li added/removed, as shown in Eq. (1):

$$V = \frac{Δ {G}_{f}}{F Δ {N}_{Li}} \qquad ( 1 )$$

where F is the Faraday constant, ΔN_{Li} is the amount of Li added/removed, and ΔG_{f} is the (molar) change in free energy of the reaction. (See, M. K. Aydinol, et al., Ab initio study of lithium intercalation in metal oxides and metal dichalcogenides. Phys. Rev. B. 56, 1354-1365 (1997).) Considering a two-phase reaction between LiₓMO and Li_{y}MO:LiₓMO+(y−x)Li→Li_{y}MO, ΔG_{f} can be approximated by the total internal energies from DFT calculations neglecting the entropic contributions (0 K),

ΔE=E(Li_{y}MO)−E(LiₓMO)−(y−x)E(Liₘₑₜₐₗ) (2)

where E(LiₓMO) and E(Li_{y}MO) are the DFT energies at the respective compositions. The neglect of entropic contributions means that the lithiation voltage profiles will follow the T=0K ground state convex hull and will consist of a series of constant voltage steps along the two-phase regions of the convex hull, separated by discontinuities which indicate the single-phase compounds on the hull. It is worth mentioning here that, in practice, lithiation/delithiation do not necessarily proceed through two-phase reactions. Thus, the calculated T=0K voltage profiles should be viewed as an approximation to the actual voltage profiles. (See, M. K. Y. Chan, et al., First principles simulations of the electrochemical lithiation and delithiation of faceted crystalline silicon. J. Am. Chem. Soc. 134, 14362-14374 (2012).) At finite temperatures (e.g., room temperature), the voltage drops in the profile become more rounded, due to entropic effects. (See, C. Wolverton, et al., First-Principles Prediction of Vacancy Order-Disorder and Intercalation Battery Voltages in LiₓCoO₂. Phys. Rev. Lett. 81, 606-609 (1998).)

### Mixing Energy

The tendency of two ordered rocksalt Li₄M₂O₅ and Li₄M₂′O₅ (space group Cmmm) materials to mix and form a mixed-metal rocksalt Li₄M₂′O₅ structure can be evaluated by calculating the mixing energy as shown in Eq. (3):

Eₘᵢₓ=E(Li₄(M,M′)₂O₅)−1/2(E(Li₄M₂O₅)+E(Li₄M′₂O₅)) (3)

where E(Li₄(M, M′)₂O₅), E(Li₄M₂O₅), and E(Li₄M′₂O₅) are the total energies of the Cmmm structure with two geometrically identical TM sites occupied by metal atoms M and M′, M alone, and M′ alone, respectively.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A lithium ion battery comprising:
an anode;
a cathode comprising a lithium mixed metal oxide compound in electrical communication with the anode, wherein the lithium mixed metal oxide compound has the formula Li₄(Mix)₂O₅, where Mix represents two or more metal cations, including a first metal cation, M, and one or more dopant metal cations, M′, the lithium mixed metal oxide compound being characterized in that it can be reversibly converted into a lithium mixed metal oxide having an energetically stable state in which the M′ cations have a valence of 5+ or above during the redox cycle of the battery; and
an electrolyte disposed between the anode and the cathode.

2. The battery of claim 1, wherein Mix consists of a first metal cation, M, one or more dopant metal cations, M′, and, optionally one or more electrochemically inert impurity metal cations.

3. The battery of claim 2, wherein M is Mn.

4. The battery of claim 1, wherein M is Mn.

5. The battery of claim 4, wherein M′ is Cr.

6. The battery of claim 4, wherein M′ is V.

7. The battery of claim 4, wherein M′ is Fe.

8. The battery of claim 4, wherein M′ is Pd.

9. The battery of claim 4, wherein M′ is Rh.

10. The battery of claim 4, wherein M′ comprises two different dopant metal cations.

11. The batter of claim 10, wherein the two different dopant metal cations are selected from the group consisting of Cr, V, Fe, Pd, and Rh.

12. The battery of claim 10, wherein the two different dopant metal cations are Cr and V.

13. The battery of claim 1, wherein the lithium mixed metal oxide compound has the formula Li₄M₍₂₋ₓ₎M′ₓO₅, where 0<x<2.

14. The battery of claim 12, wherein M is Mn.

15. The battery of claim 14, where 0<x<1.

16. The battery of claim 14, wherein the lithium mixed metal oxide compound has the formula Li₄Mn₍₂₋ₓ₎CrₓO₅.

17. The battery of claim 14, wherein the lithium mixed metal oxide compound has the formula L₄Mn₍₂₋ₓ₎CrₓO₅.

18. The battery of claim 14, wherein the lithium mixed metal oxide compound has the formula Li₄Mn₍₂₋ₓ₎FeₓO₅.

19. The battery of claim 14, wherein the lithium mixed metal oxide compound has the formula Li₄Mn₍₂₋ₓ₎PdₓO₅.

20. The battery of claim 14, wherein the lithium mixed metal oxide compound has the formula Li₄Mn₍₂₋ₓ₎RhₓO₅.

21. A lithium ion battery comprising:
an anode;
a cathode comprising Li₄Cr₂O₅ in electrical communication with the anode; and
an electrolyte disposed between the anode and the cathode.

22. A lithium ion battery comprising:
an anode;
a cathode comprising Li₄V₂O₅ in electrical communication with the anode; and
an electrolyte disposed between the anode and the cathode.

23. A lithium ion battery comprising:
an anode;
a cathode comprising Li₄Fe₂O₅ in electrical communication with the anode; and
an electrolyte disposed between the anode and the cathode.
